(19) United States
(12) Patent Application Publication
(10) Pub. No.: US 2012/0299321 A1
(43) Pub. Date: Nov. 29, 2012

(54) ORANGE PEEL GRAPPLE

(75) Inventors: Daniel J. Raihala, Superior, WI (US); Steven T. Letko, Hermantown, MN (US)

(73) Assignee: Genesis Attachments, LLC, Superior, WI (US)

(21) Appl. No.: 13/114,171

(22) Filed: May 24, 2011

(51) Int. Cl. B66C 1/42; B66C 1/58

(52) U.S. Cl. 294/201

(57) ABSTRACT

A hydraulic orange peel material handling grapple that is attachable to a boom stick on a material handling machine is used for recycling or material handling in grabbing odd shaped objects, unprocessed scrap and scooping up small items and shredded scrap. The grapple includes a central tower having at least four aligned upper and lower mounting ears circumferentially arranged equally distant from each other. A hydraulic cylinder with a ram is mounted to each upper ear. A set of at least four interchangeable pointed-shaped tines are provided for grabbing the odd shaped objections and unprocessed scrap. A set of four interchangeable flat-shaped tines that are used for scooping up small items and shredded scrap are also provided. Each tine has a cylinder ram mount ear on an upper portion of the tine for mounting the cylinder ram and an uppermost mount distal from the tine tip for pivotally mounting the tine to one of the lower frame mounting ears. The cylinder ram mount ear of the flat-shaped tine is closer to the lower tine pivot ear on the tower than the cylinder ram mount ear of the pointed-shaped tine is to the lower tine pivot mount ear.

### BACKGROUND OF THE INVENTION

The present invention relates to material handling grapples, and more particularly to a heavy duty grapple with a set of interchangeable pointed-shaped tines for grabbing odd shaped objects and unprocessed scrap and a set of four interchangeable flat-shaped tines for scooping up small items and shredded scrap. Grapples of this type are for scrap material handling typically at scrap yards and recycling centers for moving demolished material into containers, shredders or barges. These grapples are often referred to as “orange peel” grapples.

Grapple assemblies for backhoes have been around for demolition usage since the early 70's. U.S. Pat. No. 3,802,731 discloses a grapple for demolition of buildings, clearing of building sites, and raking of the ground to remove small articles of debris. In this version, the grapple unit included a stationary lower jaw which is mounted to the forwardly extending stick of a backhoe unit and also an upper jaw which was closable upon the lower jaw to crush debris therebetween. This style of grapple was not rotatable in a 360° manner as is shown in U.S. Pat. No. 4,017,114.

Referring to prior art FIG. 1, a material handling machine 10 may be seen in the form of an excavator or backhoe. These machines may be mobile or stationary. The material handling machine 10 generally includes an operator cab 12 on a frame that is rotatable in 360°. Extending upwardly and outwardly is a boom 14 that moves up or down under the operator's control of cylinder 16. Extending from boom 14 is stick 18 also controllable for moving up or down by way of cylinder 20 under the control of the operator. At the end of stick 18 is typically an attachment tool 22 secured to the end of the stick suitably with a pin 24. As shown, the tool 22 comprises a grapple 26 tearing down a building wall. The present invention rather relates to material handling operations.

Grapples have become much more sophisticated since the early 70's. FIG. 2 shows more detail of the pointed-shaped tine “orange peel” grapple 30. Pointed-shaped tine grapples 30 are currently sold by Young Corporation of Seattle Wash. Grapple 30 includes 4 or 5 pointed tines 32 with downwardly pointed ends or tips 34 (see angle between dashed lines I. and II.) which make this type of grapple suitable for use in grabbing odd shaped objects and unprocessed scrap. The grapple 30 is secured to the dipper stick 18 of the material handling machine 10 by way of pin 36. A hydraulic rotator 38 is mounted just below the pin mount 36 to permit the grapple to rotate 360° for proper orientation during the particular scooping or grabbing job. Below the rotator 38 is located the central tower 40. The tower 40 has upper cylinder mount ears 42 and lower tine pivot ears 44 that are circumferentially arranged equally distant from each other whether the grapple 30 be a 4-tine or 5-tine version. Cylinders 46 are mounted to the upper cylinder mount ears 42 while the lower tine pivot ears 44 connect the uppermost portion of the pointed-shaped tines 32 for pivotal mounting with a pin bushing or bearing assembly 48. The other ends of cylinder 46 are secured to the tines 32 to permit opening and closing of the grapple 30 during operation. It will be appreciated that the grapple 30 has slightly pointed-shaped tines 32 which readily enable it to grab and dig into scrap that is suitably in a pile.

Referring to prior art FIG. 3 a flat-shaped tine grapple 60 is shown. This style of grapple is substantially flat on the bottom to permit it to be used for scooping up small items and shredded scrap (see angle between dashed lines I. and II.) Flat-shaped tine grapples 60 are known to be made by Libherr-HydraulikbaggerGmbH of Kirchdorf, Germany. The flat-shaped tine grapple 60 typically has flat-shaped tines 62 with ends 64. The grapple 60 is mounted to the dipper stick 18 by way of pin 36 and suitably has a hydraulic rotator 38 therebelow mounted on the central tower 40. The central tower 40 of the flat-shaped tine grapple is similar to the tower 40 of the pointed tine-shaped grapple 30 in that it has upper cylinder mount ears 42 and lower tine pivot ears 44. Cylinders 46 are mounted to the upper cylinder mount ears 42 while the upper most portions of the tine 62 are mounted to the lower tine pivot ears 44 of the central tower at pivotal tine mounts 48. The other ends of cylinders 46 are connected to upper portions of tine 62 to permit the grapple to open and close its tines 62.

There are companies that make the pointed-shaped tine grapples 30 and other companies that make the flat-shaped tine grapples 60. Applicants suspect no company makes both of these style of grapples which are used for different material handling applications. Also, virtually all the parts of the known pointed-shaped tine grapples 30 and the flat-shaped tine grapples 60 are not interchangeable and thus require each their own component parts, assembly and inventory stocking space.

There is a need for a single grapple that may operate as a flat-shaped tine grapple or a pointed-shaped tine grapple simply by an interchange of the particular set of tines for the material handling work intended.

### SUMMARY OF THE INVENTION

A hydraulic orange peel material handling grapple that is attachable to a boom stick on a material handling machine is used for recycling or material handling in grabbing odd shaped objects, unprocessed scrap and scooping up small items and shredded scrap. The grapple includes a central tower having at least four aligned upper and lower mounting ears circumferentially arranged equally distant from each other. A hydraulic cylinder with a ram is mounted to each upper ear. A set of at least four interchangeable pointed-shape tines are provided for grabbing the odd shaped objects and unprocessed scrap. A set of four interchangeable flat-shaped tines that are used for scooping up small items and shredded scrap are also provided. Each tine has a cylinder ram mount ear on an upper portion of the tine for mounting the cylinder ram and an uppermost mount distal from the tine tip for pivotally mounting the tine to one of the lower frame mounting ears. The cylinder ram mount ear of the flat-shaped tine is closer to the lower tine pivot ear on the tower than the cylinder ram mount ear of the pointed-shaped tine is to the lower tine pivot mount ear.

The principal object and advantage of the present invention is that the grapple may be converted simply with the interchange of pointed-shaped tines and flat-shaped tines without other part interchange or other reconfiguration of the grapple except maybe a different cylinder guard where applicable.

Another object and advantage of the present invention is that a significant manufacturing, part costs, assembly, and warehouse storage has been eliminated by the present design which conceivably makes a pointed-shaped tine grapple or a flat-shaped tine grapple simply and only with the interchange of the flat-shaped tine set or the pointed-shaped tine set.

Another object and advantage of the present invention is that the same hydraulic cylinders will operate both the flat-shaped tines and the pointed-shaped tines.

Another object and advantage of the present invention is that it permits one company to manufacture and sell either flat-shaped tine grapples or pointed-shaped tine grapples without the associated costs with making both grapples independent of each other.

Another object and advantage of the present invention is that the end user or operator of the material handling machine may optionally use the flat-shaped tines or the pointed-shaped tines for whatever his particular material handling duty might be.

### BRIEF DESCRIPTION OF THE DRAWINGS

FIG. 1 is a prior art view of material handling machine with grapple attached thereto, demolishing a building wall.

FIG. 2 is a prior art front elevational view of a pointed-shaped tine grapple shown with its tines closed and in phantom with its tines open.

FIG. 3 is a prior art elevational view of flat-shaped tine grapple with its tines closed and shown in phantom with its tines open.

FIG. 4A is a front elevational view of the pointed-shaped tine grapple version of the present invention.

FIG. 4B is a front elevational view of the pointed-shaped tine grapple of the present invention with its tines open.

FIG. 4C is a front elevational view of a pointed-shaped tine of the present invention showing some angular relationships.

FIG. 4D is a front elevational view of the pointed-shaped tine grapple of the present invention showing angular relationships of the tine in closed and open positions shown in phantom.

FIG. 5A is a front elevational view of the flat-shaped tine grapple of the present invention with its tines open.

FIG. 5B is a front elevational view of the flat-shaped tine grapple of the present invention with its tines closed.

FIG. 5C is a front elevational view of the flat-shaped tine of the present invention showing some angular relationships.

FIG. 5D is a front elevational view of the flat-shaped tine grapple 74 of the present invention, showing some angular relationships with the tines in closed position with open position shown in phantom.

FIG. 6 is a front elevational view showing the distant relationships of the flat-shaped tines and pointed-shaped tines in relation to the ram mount ears on the tines to the tine mounts to the lower mounting ears of the tower.

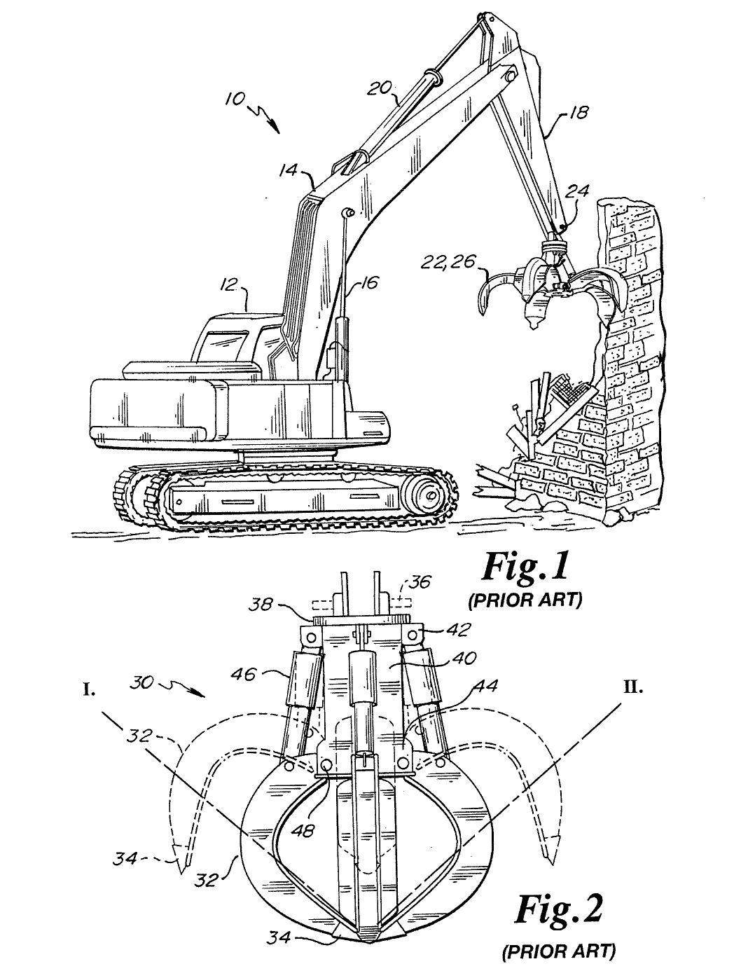

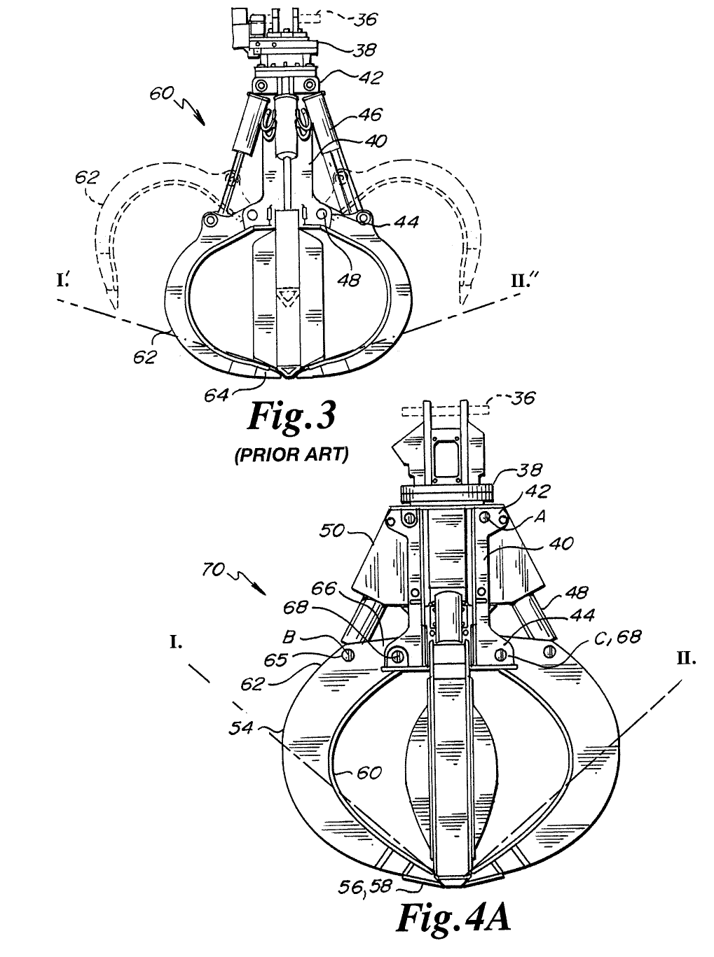

### DETAILED DESCRIPTION OF THE INVENTION

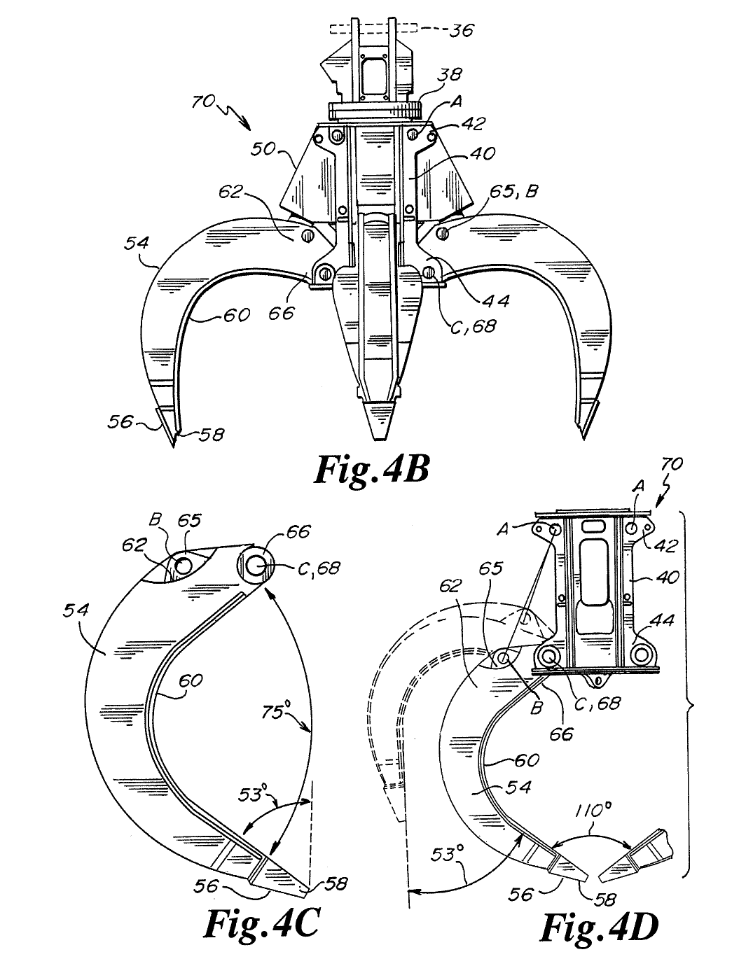

Referring to FIGS. 4A, B, C and D, the convertible pointed-shaped tine grapple 70 of the present invention may be viewed. The grapple 70 includes a rotator 38, which is suspended from the dipper stick 18 of a material handling machine 10 and held in position by pin 24. The grapple 70 includes a central tower 40 with upper cylinder mount ears 42 and lower tine pivot ears 44. The ears are spaced approximately 90 degrees apart for a four-time grapple, but may be spaced 72 degrees apart when a five-time grapple is contemplated with the present invention. The upper cylinder mount ears 42 and lower tine pivot ears 44 similarly receive mounting pins A and C. Cylinders 48, suitably are in the range of four inches in diameter and are mounted to the upper cylinder mount ears 42 at A. Guards 50 may be placed over cylinders 48 to assure that grabbed scrap does not nick or mark the cylinder rams, which may cause hydraulic fluid leaks in the cylinders 48. The pointed-shaped tine grapple 70 includes a set of four pointed-shaped tines 54, having lower ends or tips 56, which are approximately 53 degrees to vertical as shown in FIGS. 4C and 4D. Pointed-shaped tines 54 are suitably protected by hardened tips 58. The pointed-shaped tines 54 take an arcuate shape 60 of a style that permits the pointed-shaped tines 54 to be slightly pointed downward for grabbing odd-shaped objects and picking up unprocessed scrap (see angle between dashed lines I. and II.) The upper portion 62 of tines 54 have ram mount ears 65 suitably to receive a pin B to receive the ends of rams of cylinders 48. The uppermost portion 66 of the tine 54 suitably may have a pin or a journaled mount or bearing arrangement 68 for pivotal mounting of the tines 54 to the lower tine pivot ears 44 of the central tower 40. It can be appreciated that the angle between the inside of the pointed tine ends or tips 56 is approximately 110 degrees, and the angle between the end 56 and the uppermost portion 66 of the tine is approximately 75 degrees.

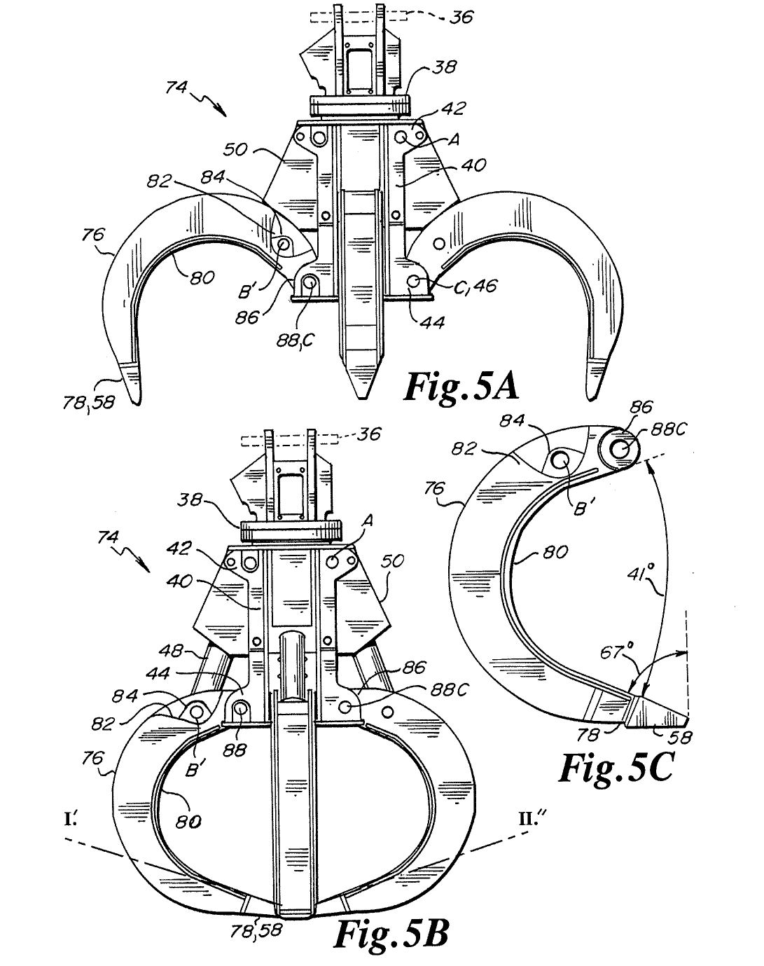

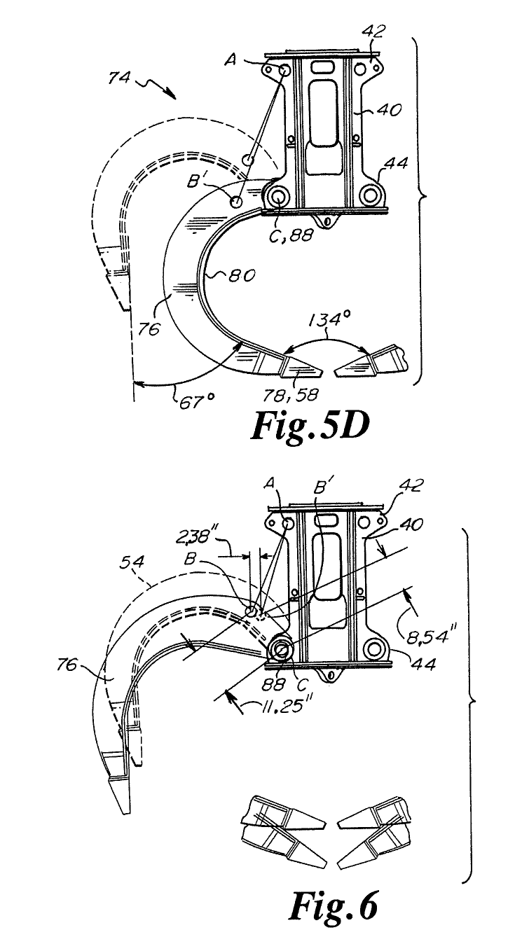

Referring to FIGS. 5A, B, C and D, the convertible flat-shaped tine grapple 74 of the present invention may be appreciated. The convertible flat-shaped tine grapple 74 of the present invention is substantially the same as pointed-shaped tine grapple 70 with respect to virtually all parts excepting some angular relationships and the location of the ram mount ears, 84 and 65 on the respective flat-shaped tines 76 and pointed-shaped tines 54. The flat-shaped tine grapple 74 has a rotator 38 held to the dipper stick 18 of the material handling machine 10 by way of pin 36. Central tower 40 includes upper cylinder mount ears 42 and lower tine pivot mount ears 44, which are represented to receive pins A and C. Cylinders 48 are mounted to the upper cylinder mount ears 42 and suitable guards 50 may be placed over to protect the cylinder rams from damage caused by the handling materials. Flat-shaped tine grapple 74 has flat-shaped tines 76 with tips or ends 78 approximately 67 degrees to vertical as shown in FIGS. 5C and 5D. The ends or tips 78 are further protected by hardened tips 58. The flat-shaped tines 76 take an arcuate shape 80 of a style that permits the flat-shaped tines 76 to scoop up small items and shredded scrap (see angle between dashed lines I′. and II′.) The upper portion 82 supports ram mount ears 84 for mounting pin B′ which secures thereat the rams of the cylinders 48. The uppermost portions 86 of flat-shaped tines 76 include a journaled mount of bearing pin arrangement 88 for mounting the flat-shaped tines 76 to the lower tine pivot ears 44 of the central tower 40. The arcuate shape 80 of the flat-shaped tines is sharper than the arcuate shape 60 of the pointed-shaped tines, in that the uppermost portion 86 to the end 78 is approximately 41 degrees, while the inside angle between opposing tines is approximately 134 degrees. By this arrangement, the flat-shaped tine grapple 74 is much more suitable for scooping up small items and shredded scrap.

Referring to FIG. 6, the interchangeability of pointed-shaped tines 54 and flat-shaped tines 76 may be appreciated. Again, the grapples 60 and 74 are substantially the same, excepting the differently configured flat-shaped tines 54 and pointed-shaped tines 76 and their angular relationship.

What is significantly novel is the geometry of the pointed-shaped tines 54 and flat-shaped tines 76 in that the pointed-shaped tine ram mount ears 65 and the flat-shaped tine ram mount ears 84, represented by B and B′ respectively, are differently spaced from the journaled/bearing mounting 88 or C of the respective tines 54 and 76. That is the distance between B to C is approximately 11.25 inches, while the distance of B′ to C is approximately 8.54 inches. By this arrangement, the same cylinders 40 may be utilized with either the pointed-shaped tine grapple 70 or the flat-shaped tine grapple 74.

Unless otherwise defined, all technical and scientific terms used herein have the same meaning as commonly understood by one of ordinary skill in the art to which this invention belongs. Although methods and materials similar to or equivalent to those described herein can be used in the practice of testing of the present invention, suitable methods and materials are not described here. The present invention may be embodied in other specific forms without departing from the spirit or essential attributes thereof, and is therefore desired that the present embodiment be considered in all respects as illustrative and not restrictive, reference being made to the appended claims rather than to the foregoing description to indicate the scope of the invention.

What is claimed is:

1. A hydraulic material handling orange peel grapple attachable to a boom stick on a material handling machine for use grabbing odd shaped objects, unprocessed scrap and scooping up small items and shredded scrap, comprising:
a) a central tower having at least four aligned upper and lower mounting ears circumferentially arranged equally distant from each other;
b) a hydraulic cylinder with ram mounted to each upper ear; and
c) a set of at least four interchangeable pointed-shaped tines for grabbing the odd shaped objects and unprocessed scrap and a set of four interchangeable flat-shaped tines for scooping up small items and shredded scrap, each tine having a cylinder ram mount ear on an upper portion of the tine and an upper most tine pivot mount distal from a tine tip for pivotally mounting the tine to the one of the lower mounting ears wherein the cylinder ram mount ear of the flat-shaped tine is closer to the tine pivot lower mounting ear on the tower than the cylinder ram mount ear of the pointed-shaped tine is to the tine pivot lower mounting ear.

2. The grapple of claim 1, wherein the flat-shaped tine cylinder ram mount is approximately 25% closer to the tine pivot mount on the tower than the pointed-shaped tine cylinder ram mount is to the tine pivot mount on the tower.

3. The grapple of claim 1, wherein the cylinder ram mount ear of the flat-shaped tine is approximately 7 to 10 inches to the tine pivot lower mounting ear on the tower and the cylinder ram mount ear of the pointed-shaped tine is 10 to 13 inches to the tine pivot lower mounting ear.

4. The grapple of claim 1, wherein the cylinder ram mount ear of the flat-shaped tine is approximately 8.5 inches to the tine pivot lower mounting ear on the tower and the cylinder ram mount ear of the pointed-shaped tine is 11.25 inches to the tine pivot lower mounting ear.

5. The grapple of claim 1, wherein the flat-shaped tine rotates approximately 67° from vertical.

6. The grapple of claim 1, wherein the flat-shaped tine tip is approximately 67° from vertical.

7. The grapple of claim 1, wherein the pointed-shaped tine rotates approximately 53° from vertical.

8. The grapple of claim 1, wherein the flat-shaped tine tip is approximately 53° from vertical.

9. The grapple of claim 1, wherein the flat-shaped tine tip is approximately 41° from the upper most tine pivot mount to the tine tip.

10. The grapple of claim 1, wherein the pointed-shaped tine tip is approximately 75° from the upper most tine pivot mount to the tine tip.

11. The grapple of claim 1, further comprising a grapple rotator on the tower.

12. The grapple of claim 1, further comprising cylinder ram guards on the cylinder covering the cylinder rams.

13. A material handling orange peel grapple attachable to a boom stick on a material handling machine for use grabbing odd shaped objects, unprocessed scrap and scooping up small items and shredded scrap, comprising:
a) a central tower having at least four aligned upper and lower mounting ears circumferentially arranged equally distant from each other;
b) a hydraulic cylinder with ram mounted to each upper ear; and
c) a set of at least four interchangeable pointed-shaped tines for grabbing the odd shaped objects and unprocessed scrap and a set of four interchangeable flat-shaped tines for scooping up small items and shredded scrap, each tine having a cylinder ram mount ear on an upper portion of the tine and an upper most tine pivot mount distal from a tine tip for pivotally mounting the tine to the one of the lower mounting ears wherein the cylinder ram mount ear of the flat-shaped tine is 20% to 30% closer to the tine pivot lower mounting ear on the tower than the cylinder ram mount ear of the pointed-shaped tine is to the tine pivot lower mounting ear.

14. The grapple of claim 13, wherein the flat-shaped tine cylinder ram mount is approximately 25% closer to the tine pivot mount on the tower than the pointed-shaped tine cylinder ram mount is to the tine pivot mount on the tower.

15. The grapple of claim 13, wherein the cylinder ram mount ear of the flat-shaped tine is approximately 7 to 10 inches to the tine pivot lower mounting ear on the tower and the cylinder ram mount ear of the pointed-shaped tine is 10 to 13 inches to the tine pivot lower mounting ear.

16. The grapple of claim 13, wherein the cylinder ram mount ear of the flat-shaped tine is approximately 8.5 inches to the tine pivot lower mounting ear on the tower and the cylinder ram mount ear of the pointed-shaped tine is 11.25 inches to the tine pivot lower mounting ear.

17. The grapple of claim 13, wherein the flat-shaped tine rotates approximately 67° from vertical.

18. The grapple of claim 13, wherein the flat-shaped tine tip is approximately 67° from vertical.

19. The grapple of claim 13, wherein the pointed-shaped tine rotates approximately 53° from vertical.

20. The grapple of claim 13, wherein the flat-shaped tine tip is approximately 53° from vertical.

21. The grapple of claim 13, wherein the flat-shaped tine tip is approximately 41° from the upper most tine pivot mount to the tine tip.

22. The grapple of claim 13, wherein the pointed tine tip is approximately 75° from the upper most tine pivot mount to the tine tip.

23. The grapple of claim 13, further comprising a grapple rotator on the tower.

24. The grapple of claim 13, further comprising cylinder ram guards on the cylinder covering the cylinder rams.

25. A hydraulic material handling orange peel grapple attachable to a boom stick on a material handling machine for use grabbing odd shaped objects, unprocessed scrap and scooping up small items and shredded scrap, comprising:
a) a central tower having at least four aligned upper and lower mounting ears circumferentially arranged equally distant from each other;
b) a hydraulic cylinder with ram mounted to each upper ear; and
c) a set of at least four interchangeable pointed-shaped tines that rotate approximately 53° from vertical for grabbing the odd shaped objects and unprocessed scrap and a set of four interchangeable flat-shaped tines that rotate approximately 67° from vertical for scooping up small items and shredded scrap, each tine having a cylinder ram mount ear on an upper portion of the tine and an upper most tine pivot mount distal from a tine tip for pivotally mounting the tine to the one of the lower mounting ears wherein the cylinder ram mount ear of the flat-shaped tine is approximately 25% closer to the tine pivot lower mounting ear on the tower than the cylinder ram mount ear of the pointed-shaped tine is to the tine pivot lower mounting ear.

26. The grapple of claim 25, wherein the cylinder ram mount ear of the flat-shaped tine is approximately 8.5 inches to the tine pivot lower mounting ear on the tower and the cylinder ram mount ear of the pointed-shaped tine is 11.25 inches to the tine pivot lower mounting ear.

27. The grapple of claim 25, wherein the flat-shaped tine tip is approximately 41° from the upper most tine pivot mount to the tine tip.

28. The grapple of claim 25, wherein the pointed-shaped tine tip is approximately 75° from the upper most mount tine pivot to the tine tip.

29. The grapple of claim 25, further comprising a grapple rotator on the tower.

30. The grapple of claim 25, further comprising cylinder ram guards on the cylinder covering the cylinder rams.
